(19) United States
(12) Patent Application Publication
(10) Pub. No.: US 2007/0202257 A1
(43) Pub. Date: Aug. 30, 2007

(54) Production method of multilayer ceramic electronic device

(75) Inventor: Toshio Sakurai, Nikaho-city (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/709,048

(22) Filed: Feb. 22, 2007

(30) Foreign Application Priority Data
Feb. 28, 2006 (JP) 2006-053971

(51) Int. Cl. B05D 5/00

(52) U.S. Cl. 427/258

(57) ABSTRACT

A production method of a multilayer ceramic electronic device comprising the steps of forming a first green sheet 10a by first paint on a surface of a carrier sheet 20, forming a first electrode pattern layer 12a by second paint on a surface of the first green sheet 10a, forming a second green sheet 10b by third paint on a surface of the first green sheet 10a having the first electrode pattern layer 12a formed thereon, forming a second electrode pattern layer 12b by fourth paint on a surface of the second green sheet 10b, and forming a third green sheet 10c by first paint on a surface of the second green sheet 10b having the second electrode pattern layer 12b formed thereon; wherein the first paint and the second paint are insoluble to each other, the third paint is insoluble to the first paint and second paint, and the third paint and the fourth paint are insoluble to each other; by which a sheet attack does not arise when forming an electrode pattern layer on a surface of a green sheet, and a short-circuiting defect rate of electronic devices is low.

### BACKGROUND OF THE INVENTION

1. Field of the Invention

The present invention relates to a production method of a multilayer ceramic electronic device, such as a multilayer ceramic capacitor, and particularly relates to a production method of a multilayer ceramic electronic device, by which a so-called sheet attack phenomenon does not arise when forming an electrode pattern layer on a surface of a green sheet and a short-circuiting defect rate of the resulting electronic devices is low.

2. Description of the Related Art

As a method of producing a multilayer ceramic electronic device, such as a capacitor, piezoelectric element, PTC thermister, NTC thermister and varister, for example, a method described below is known. Namely, first, ceramic paint including a ceramic powder, organic binder, plasticizer and solvent, etc. is formed to be a sheet shape on a flexible carrier sheet (for example, PET film) by the doctor blade method, etc., so that a green sheet is obtained. On the green sheet, paste including an electrode material, such as palladium, silver and nickel, is printed in a predetermined pattern to form an electrode pattern layer.

To obtain a multilayer structure, the obtained green sheets are stacked to attain a desired multilayer structure. Then, a press cutting step is performed to obtain a ceramic green chip. A binder in the thus obtained green chip is burnt out, fired at 1000 to 1400° C., terminal electrodes of silver, silver-palladium, nickel or copper, etc. are formed on the obtained fired body, so that a ceramic multilayer ceramic electronic device is obtained.

In the above production method, for example when producing a multilayer ceramic capacitor, a method of making a thickness of one dielectric layer thinner and increasing the number of stacked layers may be considered to attain a compact body with a larger capacity. However, when peeling the green sheet from the flexible carrier sheet, the green sheet is not easily peeled from the flexible carrier sheet particularly when the green sheet is thin and the yield of stacking layers largely declines. Also, by handling thin green sheets, short-circuiting and other characteristic defects often arise in the finally produced products.

As a means for solving the above disadvantages, there has been considered a method of obtaining a multilayer body by repeating steps consisting of forming a green sheet and printing electrodes on the green sheet (sheet applying and printing) exactly for the number of times of required layers. As a result, a total thickness of the sheets increases, so that the sheets can be peeled from the carrier sheet without damaging the sheets (refer to the Japanese Patent Publication No. 3190177).

However, disadvantages below remain in this production method. The first point is that the step of printing an electrode pattern on the dried first green sheet is performed by the Wet-on-Dry method, which results in disadvantages. Namely, the first sheet is corroded by a solvent used at printing the electrodes (sheet attack by the solvent arises) and a thickness of the sheet becomes thinner at parts under the electrode printed portions, so that short-circuiting defects easily arise.

The second point is that, taking a second layer as an example, when applying the second sheet on a first layer by the Wet-on-Dry method, paint of the second layer permeates to the dried first layer. As a result, there arise disadvantages that sheet thicknesses of the first layer and the second layer vary, pinhole, etc. arise and characteristics of the product are affected.

The third point is that, taking the second layer as an example, since the Wet-on-Dry method is used in the step of printing electrodes after applying the second sheet, the second sheet is corroded by a solvent used at printing electrodes (a sheet attack by the solvent). As a result, a thickness of the sheet becomes thin at parts under the electrode printed parts, so that short-circuiting defects are easily caused.

Particularly, when a thickness of one sheet becomes 1 μm or thinner, the above disadvantages become notable and it becomes difficult to produce a compact multilayer ceramic capacitor having a large capacity.

### SUMMARY OF THE INVENTION

An object of the present invention is to provide a production method of a multilayer ceramic electronic device, by which a so-called sheet attack phenomenon is not occurred when forming an electrode pattern layer on a surface of a green sheet and a short-circuiting defect rate becomes low in electronic devices produced thereby.

To attain the above object, according to the present invention, there is provided a production method of a multilayer ceramic electronic device, comprising the steps of:
forming a first green sheet (a green sheet as the first layer) by first paint; and

forming a first electrode pattern layer (electrode pattern layer on the first layer) by second paint so as to contact with the first green sheet;

wherein the first paint and the second paint are insoluble to each other.

In the method according to the present invention, an order of forming the first green sheet and forming of the first electrode pattern layer is not restricted. For example, the first electrode pattern layer may be formed first and, then, the first green sheet may be formed on a surface of the first electrode pattern layer. In the present invention, preferably, the first green sheet is formed on a surface of the carrier sheet first and, then, the first electrode pattern layer is formed on the surface of the first green sheet.

In the method according to the present invention, the first paint and the second paint are insoluble to each other. Therefore, even when the first electrode pattern layer formed by the second paint is formed on a surface of the first green sheet formed by the first paint by a printing method, etc., a solvent included in the first electrode pattern layer does not corrode the first green sheet (a sheet attacked by the solvent does not arise). As a result, short-circuiting defects of multilayer ceramic electronic devices can be reduced.

Preferably, the method of the present invention further comprises the steps of

forming a second green sheet (a green sheet as the second layer) by third paint on a surface of the first green sheet having the first electrode pattern layer formed thereon, and

forming a second electrode pattern layer (an electrode pattern layer on the second layer) by fourth paint on a surface of the second green sheet;

wherein:

the third paint is insoluble to the first paint and the second paint; and
the third paint and the fourth paint are insoluble to each other.

The third paint is insoluble to the first paint and the second paint. Therefore, when forming the second layer (the second green sheet formed by the third paint), permeation of paint from the second layer to the first layer (the first green sheet formed by the first paint, and the first electrode pattern layer formed by the second paint) can be prevented. As a result, such disadvantages that a sheet thickness does not become even and formation of pinholes, etc. hardly arise.

Also, the third paint and the fourth paint are insoluble to each other. Therefore, even when forming the second electrode pattern layer by the fourth paint on the surface of the second green sheet formed by the third paint by a printing method, etc., a solvent included in the second electrode pattern layer dose not corrode the green sheet (a sheet attack by the solvent does not arise). As a result, short-circuiting defects of electronic devices can be reduced.

Preferably, the method of the present invention further comprises forming a third green sheet (a green sheet as the third layer) by the first paint on a surface of the second green sheet having the second electrode pattern layer formed thereon.

Preferably, the method of the present invention further comprises the steps of:

forming a plurality of multilayer units having the first green sheet, the first electrode pattern layer, the second green sheet, the second electrode pattern layer and the third green sheet on a carrier sheet;

peeling the carrier sheet from each of the multilayer units; and

stacking a plurality of the multilayer units, so that adjacent two multilayer units are in a relationship that the first green sheet included in one of the multilayer units contacts with the third green sheet included in the other multilayer unit.

The plurality of multilayer units are stacked in a stacking and pressing step. When stacking, a third green sheet of one multilayer unit contacts with a first green sheet of another multilayer unit. The first green sheet and the third green sheet are formed by the same kind of the first paint. Accordingly, the both can be well bonded when contacting and stacking the first green sheet of other multilayer unit on the third green sheet.

Also, since the multilayer unit is thicker than single green sheet, it has high strength. Therefore, the multilayer unit can be easily peeled from the flexible carrier sheet without damaging the multilayer unit.

Preferably, a sum of a thickness t1 of the first green sheet and a thickness t3 of the third green sheet (t1+t3) is equal to a thickness t2 of the second green sheet.

The multilayer units are stacked in the stacking and pressing step. When stacking, the third green sheet contacts with the first green sheet. Therefore, a set of the first green sheet and the third green sheet compose one dielectric layer in the multilayer ceramic electronic device. On the other hand, the second green sheet composes one dielectric layer alone. Accordingly, by making a sum of the thickness t1 of the first green sheet and the thickness t3 of the third green sheet equal to the thickness t2 of the second green sheet, thicknesses of dielectric layers in the multilayer ceramic electronic device can be unified.

Preferably, a thickness t1 of the first green sheet is 1.0 μm or thinner, and more preferably 0.5 μm or thinner. Also, a thickness t2 of the second green sheet is preferably 1.0 μm or thinner.

As explained above, even when the green sheets are made to be thin, sheet attacks can be prevented in a stacking step and short-circuiting defects of multilayer ceramic electronic devices can be prevented.

Preferably, a first blank pattern layer formed by the first paint is formed to have substantially the same thickness as that of the first electrode pattern layer on a part of a surface of the first green sheet, where the first electrode pattern layer is not formed.

Also preferably, a second blank pattern layer formed by the third paint is formed to have substantially the same thickness as that of the second electrode pattern layer on a part of a surface of the second green sheet, where the second electrode pattern layer is not formed.

By forming the blank pattern layer, even when a green sheet is formed on an electrode pattern layer, a level difference does not arise on the green sheet and a chip shape becomes better after stacking.

Preferably, the first paint is organic solvent based paint;

the second paint is organic solvent based paint being insoluble to the first paint;

the third paint is water based paint being insoluble to the first paint and the second paint; and

the fourth paint is organic solvent based paint being insoluble to the third paint.

By using organic solvent based paint being insoluble to each other as the first paint and the second paint, a sheet attack can be prevented between the first green sheet formed by the first paint and the first electrode pattern layer formed by the second paint.

By using as the third paint water based paint being insoluble to the first paint and the second paint, when forming a second layer (the second green sheet formed by the third paint), permeation of paint from the second layer to the first layer (the first green sheet formed by the first paint and the first electrode pattern layer formed by the second paint) can be prevented. Therefore, such disadvantages that a sheet thickness does not become even and formation of pinholes, etc. hardly arise.

By using paints being insoluble to each other as the third paint and the fourth paint, sheet attacks can be prevented between the second green sheet formed by the third paint and the second electrode pattern layer formed by the fourth paint.

Preferably, the first paint includes at least either one of a butyral resin and an acrylic resin as a binder resin.

Preferably, the third paint includes at least either one of a water-soluble polyvinyl acetal resin and a water-soluble acrylic resin as a binder resin.

Comparing with resins being soluble to water based paint, such as a water-soluble polyvinyl acetal resin and a water-soluble acrylic resin, resins being soluble to organic solvent based paint, such as a butyral resin and an acrylic resin, have higher resin strength. Accordingly, when forming the first green sheet from the first paint including a butyral resin or an acrylic resin, the sheet strength improves. As a result, when peeling the multilayer unit from the flexible carrier sheet, it is possible to prevent damaging of the first green sheet.

### BRIEF DESCRIPTION OF DRAWINGS

These and other objects and features of the present invention will become clearer from the following description of the preferred embodiments given with reference to the attached drawings, in which:

FIG. 1 is a schematic sectional view of a multilayer ceramic capacitor according to an embodiment of the present invention;

FIG. 2 is a sectional view of a key part showing a production step of a production method of the multilayer ceramic capacitor shown in FIG. 1;

FIG. 3 is a sectional view of a key part showing a production step of a production method of the multilayer ceramic capacitor shown in FIG. 1; and

FIG. 4A and FIG. 4B are pictures of sections of multilayer ceramic capacitors according to examples of the present invention.

### DESCRIPTION OF THE PREFERRED EMBODIMENT

Below, the present invention will be explained based on an embodiment shown in drawings.

[Overall Configuration of Multilayer Ceramic Capacitor]

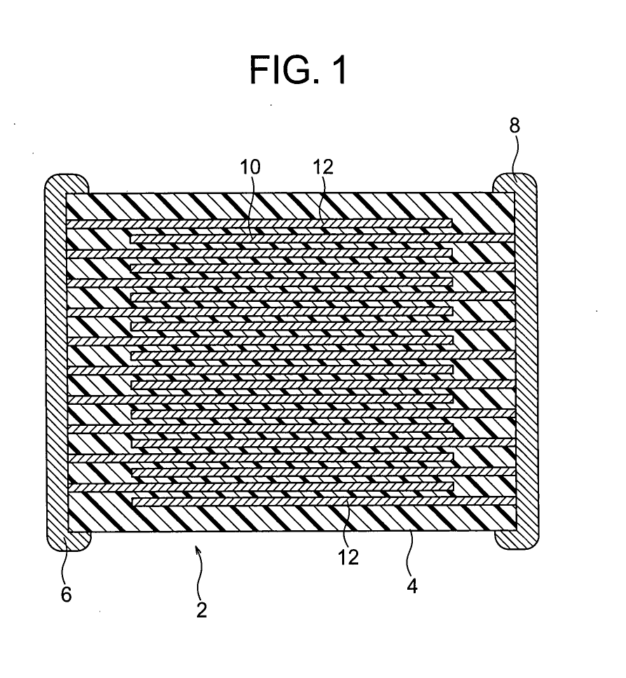

First, as an embodiment of an electronic device produced by the method according to the present invention, an overall configuration of a multilayer ceramic capacitor will be explained. As shown in FIG. 1, a multilayer ceramic capacitor 2 according to the present embodiment comprises a capacitor element body 4, a first terminal electrode 6 and a second terminal electrode 8. The capacitor element body 4 comprises dielectric layers 10 and internal electrode layers 12, and the internal electrode layers 12 are alternately stacked between the dielectric layers 10. The alternately stacked internal electrode layers 12 on one side are electrically connected to inside of the first terminal electrode 6 formed outside of a first end portion of the capacitor element body 4. Also, the alternately stacked internal electrode layers 12 on the other side are electrically connected to inside of the second terminal electrode 8 formed outside of a second end portion of the capacitor element body 4.

A material of the dielectric layers 10 is not particularly limited and it may be composed of dielectric materials, such as calcium titanate, strontium titanate and/or barium titanate. A thickness of each dielectric layer 10 is not particularly limited but is generally several μm to hundreds of μm. Particularly in this embodiment, it is made as thin as preferably 3 μm or thinner, more preferably 1.5 μm or thinner, and particularly preferably 1 μm or thinner.

Also, a material of the terminal electrodes 6 and 8 is not particularly limited and copper, copper alloys, nickel and nickel alloys, etc. are normally used. Silver and an alloy of silver and palladium, etc. may be also used. A thickness of the terminal electrodes 6 and 8 is not particularly limited and is normally 10 to 50 μm or so.

A shape and size of the multilayer ceramic capacitor 2 may be suitably determined in accordance with the use object. When the multilayer ceramic capacitor 2 has a rectangular parallelepiped shape, it is normally a length (0.6 to 5.6 mm, preferably 0.6 to 3.2 mm)×width (0.3 to 5.0 mm, preferably 0.3 to 1.6 mm)×thickness (0.1 to 1.9 mm, preferably 0.3 to 1.6 mm) or so.

Next, an example of production methods of the multilayer ceramic capacitor 2 according to the present embodiment will be explained. First, compositions of first to fourth paint to be used in production will be explained.

First Paint (First Green Sheet Paste)

In the present embodiment, a first green sheet is formed from first paint. As the first paint, an organic solvent based paint or water based paint is used. Organic solvent based paint is preferably used in the present embodiment. The first paint is obtained by kneading a dielectric material and an organic vehicle. Wherein the organic vehicle is obtained by dissolving a binder resin in an organic solvent.

The dielectric material may be suitably selected from composite oxides and a variety of compounds to be oxides, for example, carbonates, nitrites, hydroxides and organic metal compounds, etc. and mixed for use. The dielectric material is normally used as a powder having an average particle diameter of 0.3 μm or smaller, more preferably 0.2 μm or smaller. Wherein, to form an extremely thin green sheet, it is preferable to use a finer powder than a thickness of the green sheet.

In the present embodiment, those being soluble in organic solvent based paint are used as the binder resin to be used for an organic vehicle of the first paint. As a binder resin being soluble in an organic solvent based paint, generally, an acrylic resin, butyral based resin such as polyvinyl butyral, polyvinyl acetal, polyvinyl alcohol, polyolefin, polyurethane, polystyrene, organics composed of copolymers of these, emulsion, etc. may be mentioned. In the present embodiment, at least one of a butyral resin and an acrylic resin is preferably used.

When using a butyral based resin as the binder resin, a content of a plasticizer is preferably 25 to 100 parts by weight with respect to 100 parts by weight of the binder resin. When the plasticizer is too little, the green sheet tends to become weak, while when too much, the plasticizer exudes and the handleability of the green sheet becomes poor.

When using an acrylic resin as the binder resin, a content of the plasticizer is preferably 25 to 100 parts by weight with respect to 100 parts by weight of the binder resin. When the plasticizer is too little, the green sheet tends to become weak, while when too much, the plasticizer exudes and the handleability becomes poor.

The organic solvent to be used for the organic vehicle is not particularly limited as far as the above binder is dissolved therein and an organic solvent, such as terpineol, alcohol, butyl carbitol, acetone, methylethyl ketone (MEK), toluene, xylene, ethyl acetate, butyl stearate and isobornyl acetate, is used. In the present embodiment, methylethyl ketone and toluene are preferably used. A content of each component in the first paint is not particularly limited and may be a normal content, for example, about 1 to 5 wt % of a binder resin and about 10 to 50 wt % of an organic solvent.

The first paint may contain additives selected from a variety of dispersants, plasticizers, dielectrics, glass frits, insulators and antistatic agents, etc. in accordance with necessity. With the proviso that a total content of them is preferably 10 wt % or smaller. As a plasticizer, dioctyl phthalate (DOP), benzylbutyl phthalate and other phthalate ester, adipic acid, phosphate ester and glycols, etc. may be mentioned.

Second Paint (First Electrode Pattern Layer Paste)

In the present embodiment, a first electrode pattern layer is formed from second paint. Those insoluble to the first paint are used as the second paint. In the present embodiment, an organic solvent based paint being insoluble to the first paint is used as the second paint. The second paint is fabricated by kneading a conductive material composed of a variety of conductive metals or alloys or a variety of oxides, organic metal compounds or resinates, etc. to be the conductive materials as above after firing with an organic vehicle.

As a conductor material to be used when producing the second paint, Ni, a Ni alloy or a mixture of these is used. A shape of the conductor material is not particularly limited and may be a sphere shape, a scale shape or a mixture of these shapes. Also, a conductor material having an average particle diameter of normally 0.1 to 2 μm, and preferably 0.2 to 1 μm or so may be used.

In the present embodiment, ethyl cellulose, polyvinyl butyral, etc. may be mentioned as a binder resin to be included in the second paint. Preferably, ethyl cellulose is used. The binder resin for the second paint is included in an amount of preferably 4 to 10 parts by weight in the electrode paste with respect to 100 parts by weight of the conductor material (metal powder).

In the present embodiment, preferably those being insoluble to the first paint are used as a solvent of the second paint. For example, terpineol and dihydro terpineol, etc. may be mentioned as the solvent of the second paint. Preferably, dihydro terpineol is used. A content of the solvent for the second paint is preferably 20 to 55 wt % or so with respect to the entire second paint.

Preferably, the second paint includes a plasticizer or an adhesive compound. Consequently, adhesiveness and stickiness are improved in each of the electrode pattern layers and green sheets. As the plasticizer, those used in the first paint may be used, and an amount of the plasticizer in the second paint is preferably 10 to 300 parts by weight, and more preferably 10 to 200 parts by weight with respect to 100 parts by weight of the binder. Note that when the adding quantity of the adhesive agent or adhesive compound is too large, it is liable that strength of the first electrode pattern layer remarkably declines.

Third Paint (Second Green Sheet Paste)

In the present embodiment, a second green sheet is formed from third paint. As the third paint, those being insoluble to the first paint and second paint are used. In the present embodiment, water-based paint being insoluble to the first paint and second paint is used as the third paint.

In the present embodiment, the first paint includes a binder resin soluble to an organic solvent, while the third paint preferably includes a water-soluble binder not soluble to an organic solvent. As the water-soluble binder, polyvinyl alcohol, methyl cellulose, hydroxyethyl cellulose, a water-soluble polyvinyl acetal resin, a water-soluble acrylic resin and emulsion, etc. may be mentioned. In the present embodiment, preferably at least either of a water-soluble polyvinyl acetal resin and a water-soluble acrylic resin is used.

In the present embodiment, ion-exchange water is preferably used as a solvent for the third paint. Also, the third paint may include a surfactant.

Contents of the above components in the third paint are not particularly limited and may be normal contents, for example, 5 to 10 wt % or so of the binder and 10 to 50 wt % or so of the solvent (ion-exchange water).

Other components than the binder resin and solvent to be included in the third paint may be the same as those in the first paint.

Fourth Paint (Second Electrode Pattern Layer Paste)

In the present embodiment, a second electrode pattern layer is formed from fourth paint. As the fourth paint, those being insoluble to the third paint are used as the fourth paint. In the present embodiment, organic solvent based paint being insoluble to the third paint is used as the fourth paint. More preferably, organic solvent based paint being insoluble to the third paint and first paint is used as the fourth paint. As the fourth paint, for example, the same paint as the second paint may be used.

First Layer Stacking Step

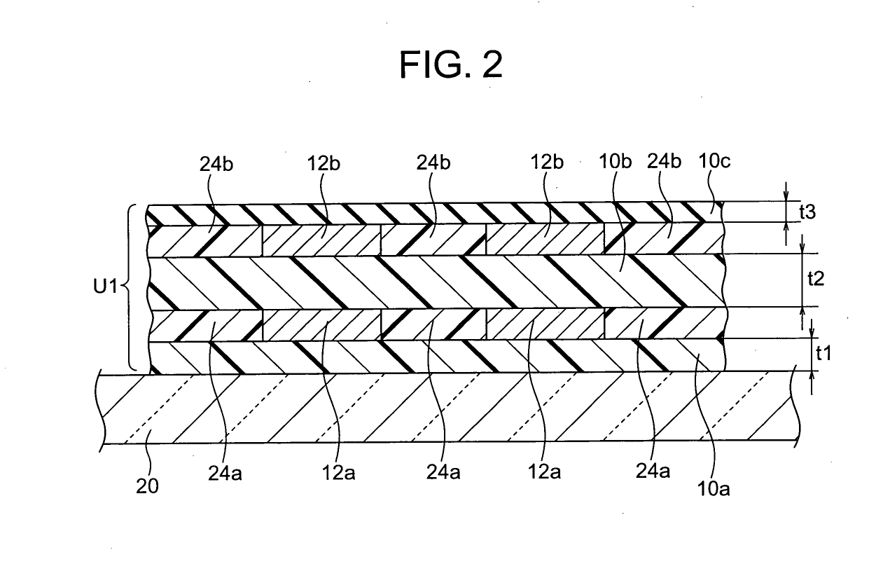

Next, respective production steps will be explained. First, as shown in FIG. 2, the first paint is applied on a carrier sheet 20 (support) to form a first green sheet 10a. The formed first green sheet 10a is dried if necessary. A drying temperature of the first green sheet 10a is preferably 50 to 100° C. and drying time is preferably 1 to 20 minutes. A thickness of the green sheet 10a after drying is contracted to 5 to 25% of that before drying. The thickness t1 of the dried green sheet is preferably 1.0 μm or thinner, more preferably 0.5 μm or thinner.

A method of forming the first green sheet 10a is not particularly limited and the die coating method and doctor blade method, etc. may be mentioned.

As the carrier sheet 20, for example, a PET film, etc. is used, and those coated with silicon, etc. are preferable to improve the releasing capability. A thickness of the carrier sheet 20 is not particularly limited, but is preferably 5 to 100 μm.

Next, the second paint is printed to be a predetermined pattern on a surface of the first green sheet 10a formed on the carrier sheet 20 to from a first electrode pattern layer 12a. Before or after the formation of the first electrode pattern layer 12a, the first paint is printed on the surface of the green sheet 10a, where the first electrode pattern layer 12a is not formed thereon, to form a first blank pattern layer 24a having substantially the same thickness as that of the electrode pattern layer 12a.

By forming the first blank pattern layer 24a, even when a second green sheet 10b is formed on the first electrode pattern layer 12a, a level difference, etc. does not arise on the second green sheet 10b and a chip shape after stacking also becomes better.

As a method of forming the electrode pattern layer 12a, a printing method as explained above (screen printing method and gravure printing method) and other thick film formation method, or a thin film method, such as vapor deposition and sputtering may be mentioned. In the present embodiment, a printing method is preferably used.

The first blank pattern layer 24a is formed by the same method as the first electrode pattern layer 12a.

The first electrode pattern layer 12a and the first blank pattern layer 24a are dried in accordance with necessity. The drying temperature is not particularly limited, but preferably 70 to 120° C., and the drying time is preferably 5 to 15 minutes. Thicknesses of the first electrode pattern layer 12a and the first blank pattern layer 24a after drying are not particularly limited but is about 30 to 80% of the thickness t1 of the first green sheet 10a after drying.

Second Layer Stacking Step

Next, as shown in FIG. 2, the third paint is applied on the first electrode pattern layer 12a and the first blank pattern layer 24 to form the second green sheet 10b. The second green sheet 10b is formed by the same method as the first green sheet 10a.

The formed second green sheet 10b is dried if necessary. A thickness t2 of the second green sheet 10b after drying is contracted to 5 to 25% of that before drying. The thickness t2 of the second green sheet 1b after drying is preferably 1.0 μm or thinner.

Next, the fourth paint is printed to be in a predetermined pattern on a surface of the second green sheet 10b to form a second electrode pattern layer 12b. Also, before or after the formation of the second electrode pattern layer 12b, the third paint is printed on a part of the surface of the second green sheet 10b, where the second electrode pattern layer 12b is not formed, to form a second blank pattern layer 24b having substantially the same thickness as that of the second electrode pattern layer 12b.

By forming the second blank pattern layer 24ab, even when a third green sheet 10c is formed on the second electrode pattern layer 12b, a level difference, etc. does not arise on the third green sheet 10c and a chip shape after stacking also becomes better.

The second electrode pattern layer 12b and the second blank pattern layer 24b are formed and dried in the same way as the first electrode pattern layer 12a and the first blank pattern layer 24a.

Next, the first paint is applied on a surface of the second electrode pattern layer 12b and the second blank pattern layer 24b to form a third green sheet 10c, so that a multilayer unit U1 is obtained. The third green sheet 10c is formed by the same method as the first green sheet 10a and the second green sheet 10b.

The third green sheet 10c is dried in accordance with necessity. A drying condition of the third green sheet 10c is the same as that in the first green sheet 10a.

A thickness t3 of the third green sheet 10c after drying is preferably determined to become approximately equal to a value obtained by subtracting the thickness t1 of the first green sheet 10a from the thickness t2 of the second green sheet 10b. Namely, it is preferable that a relation of t1+t3=t2 stands. Also preferably, the thickness t3 and the thickness t1 are approximately equal. For example, when t2=about 1 μm, it is preferable that t1=t3=about 0.5 μm.

In the present embodiment, one multilayer unit U1 is composed of the first green sheet 10a, the first electrode pattern layer 12a and the first blank pattern layer 24a as the first layer, the second green sheet 10b, second electrode pattern layer 12a and the second blank pattern layer 24b as the second layer, and the third green sheet 10c. A large number of the multilayer units U1 are stacked in the next step.

Multilayer Unit U1 Stacking and Pressing Step

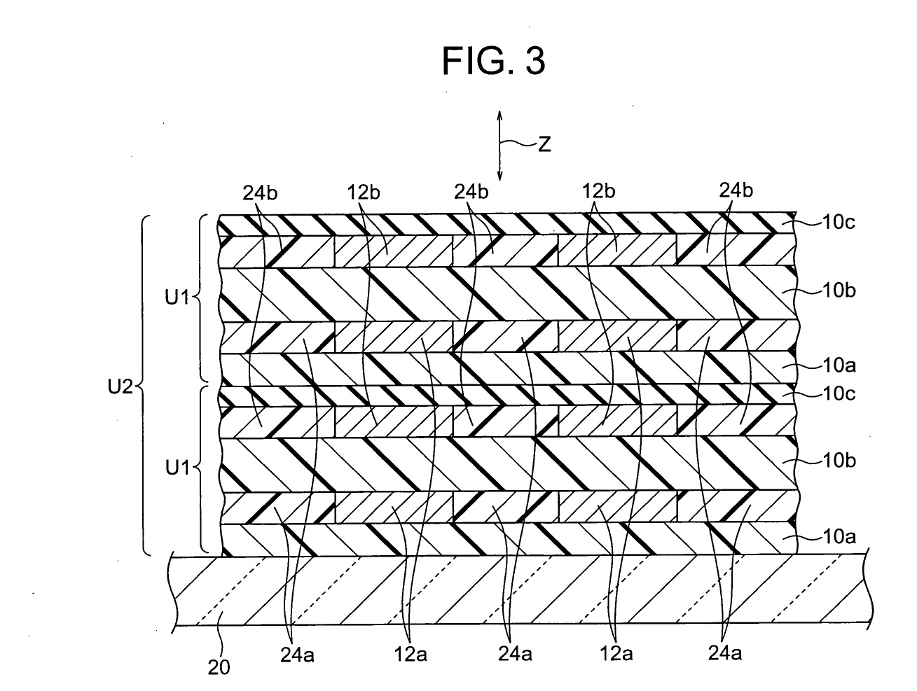

Next, in the stacking and pressing step, as shown in FIG. 3, the multilayer units U1 are stacked, so that the third green sheet 10c of the multilayer unit U1 peeled from the carrier sheet 20 contacts with the first green sheet 10a of another multilayer unit U1 stacked on the carrier sheet 20. By repeating the stacking of the multilayer units U1 as such, a multilayer body, wherein a large number of green sheets and electrode pattern layers are stacked on the stacking direction Z, is obtained.

Between the first electrode pattern layer 12a and the second electrode pattern layer 12b next to each other in the stacking direction Z, there is one second green sheet 10b or a set of one first green sheet 10a and one third green sheet 10c. In the present embodiment, by keeping t1+t3=t2, an interval between the first electrode pattern layer 12a and the second electrode pattern layer 12b next to each other in the stacking direction Z can become approximately constant. The thickness t1 and the thickness t3 do not have to be always the same, but when one of the two is too thick, the other becomes too thin and formation of the thin layer tends to become difficult.

In the present embodiment, a large number of multilayer units U1 are stacked in the stacking direction Z, the obtained multilayer body is heated and pressurized, then, cut into a predetermined size, so that a green chip is formed. While not illustrated, exterior green sheets not having an electrode pattern layer formed thereon are stacked on both ends in the stacking direction Z of the multilayer unit U1. The heating temperature is preferably 40 to 10° C. The pressure at pressurizing is preferably 10 to 200 MPa.

In the present embodiment, the first electrode pattern layers 12a and second electrode pattern layers 12b (FIG. 3) in the green chip become internal electrode layers 12 (FIG. 1) after firing, and the second green sheets 10b or sets of one first green sheet 10a and one third green sheet 10c (FIG. 3) become the dielectric layers 10 (FIG. 1) after firing.

Binder Removal Processing, Firing Processing and Thermal Treatment of Green Chip

Next, the green chip is subjected to binder removal processing, firing processing and thermal treatment for re-oxidizing the dielectric layers.

The binder removal processing may be performed under a normal condition, but when using Ni, a Ni alloy or other base metal as a conductive material of the electrode pattern layer, the condition below is particularly preferable.

Temperature raising rate: 5 to 300° C./hour, preferably 10 to 50° C./hour

Holding temperature: 200 to 400° C., preferably 250 to 350° C.

Holding time: 0.5 to 20 hours, preferably 1 to 10 hours

Atmosphere gas: wet mixed gas of N₂ and H₂

The firing condition is preferably as below.

Temperature raising rate: 50 to 500° C./hour, preferably 200 to 300° C./hour

Holding temperature: 1100 to 1300° C., preferably 1150 to 1250° C.

Holding time: 0.5 to 8 hours, preferably 1 to 3 hours

Cooling rate: 50 to 500° C./hour, preferably 200 to 300° C./hour

Atmosphere gas: wet mixed gas of N₂+H₂, etc.

An oxygen partial pressure of an air atmosphere at firing is preferably 10⁻² Pa or lower, and particularly 10⁻⁸ to 10⁻² Pa. When exceeding the range, the internal electrode layers tend to be oxidized, while when the oxygen partial pressure is too low, it is liable that abnormal sintering is caused in conductive materials of the internal electrode layers to result in breaking.

The thermal treatment after the firing as above is preferably performed with a holding temperature or a highest temperature of preferably 1000° C. or higher, and more preferably 1000 to 1100° C. An oxygen partial pressure at the thermal treatment is higher than that in the reducing atmosphere at firing and is preferably 10⁻³ Pa to 1 Pa, and more preferably 10⁻² Pa to 1 pa.

Other thermal treatment condition is preferably as below.

Holding time: 0 to 6 hours, particularly 2 to 5 hours

Cooling rate: 50 to 500° C./hour, particularly 100 to 300° C./hour

Atmosphere gas: wet N₂ gas, etc.

To prepare the wet N₂ gas and mixed gas, etc., for example, a device for making a gas flow through heated water to generate bubbles may be used. In that case, the water temperature is preferably 0 to 75° C. or so. The binder removal processing, firing and thermal treatment may be performed continuously or separately.

When performing continuously, the atmosphere is changed without cooling after the binder removal processing, continuously, the temperature is raised to the holding temperature at firing to perform firing. Next, it is cooled and the thermal treatment is preferably performed by changing the atmosphere when the temperature reaches to the holding temperature of the thermal treatment.

On the other hand, when performing them separately, at the time of firing, after raising the temperature to the holding temperature of the binder removal processing in an atmosphere of a nitrogen gas or a wet nitrogen gas, the atmosphere is changed, and the temperature is preferably furthermore raised. After that, after cooling the temperature to the holding temperature of the thermal treatment, it is preferable that the cooling continues by changing the atmosphere again to a N2 gas or a wet N₂ gas. Also, in the thermal treatment, after raising the temperature to the holding temperature under the N2 gas atmosphere, the atmosphere may be changed, or the entire process of the annealing may be in a wet N₂ gas atmosphere.

End surface polishing, for example, by barrel polishing or sand blast, etc. is performed on the sintered body (capacitor element body 4 in FIG. 1) obtained as above, and external electrode paste is burnt to form external electrodes 6 and 8. A firing condition of the external electrode paste is preferably, for example, at 600 to 800° C. in a wet mixed gas of N₂ and H₂ for 10 minutes to 1 hour or so. A pad layer is formed by plating, etc. on the surface of the external electrodes 6 and 8 if necessary. The terminal electrode paste may be fabricated in the same way as the second paint or the fourth paint (electrode pattern layer paste) explained above.

A multilayer ceramic capacitor 2 of the present invention produced as above is mounted on a print substrate, etc. by soldering, etc. and used for a variety of electronic apparatuses, etc.

In the production method of the present embodiment, the first paint and the second paint are insoluble to each other. Therefore, as shown in FIG. 2, when forming the first electrode pattern layer 12a by the second paint on a surface of the first green sheet 10a formed by the first paint, a solvent included in the first electrode pattern layer 12a does not corrode the first green sheet 10a (a sheet attack by the solvent does not occur). As a result, short-circuiting of the multilayer ceramic capacitor 2 in FIG. 1 can be reduced.

In the production method of the present embodiment, the third paint is not soluble to the first paint and the second paint. Therefore, as shown in FIG. 2, when forming the second layer (the second green sheet 10b formed by the third paint), permeation of paint from the second layer to the first layer (the first electrode pattern layer 12a formed by the second paint and the first blank pattern layer 24a formed by the first paint) can be prevented. Therefore, such disadvantages that the sheet thickness does not become even and formation of pinholes, etc. hardly arise.

In the production method of the present invention, the fourth paint and the third paint are insoluble to each other. Therefore, when forming the second electrode pattern layer 12b by the fourth paint on a surface of the second green sheet 10b formed by the third paint, a solvent included in the second electrode pattern layer 12b does not corrode the second green sheet 10b (a sheet attack by the solvent does not occur). As a result, short-circuiting defects of the multilayer ceramic capacitor 2 in FIG. 1 can be reduced.

In the production method of the present embodiment, when stacking the multilayer units U1 shown in FIG. 3, the third green sheet 10c of one multilayer unit U1 contacts with the first green sheet 10a of another multilayer unit U1. The first green sheet 10a and the third green sheet 10c are formed by the same kind of first paint. Accordingly, when stacking the multilayer units U1, the both can be well bonded.

Also, since the multilayer unit U1 is thicker than a green sheet, it has high strength. Therefore, the multilayer unit can be easily peeled from the carrier sheet 20 without damaging the unit U1.

In the production method of the present embodiment, the first paint is organic solvent based paint, and the second paint is organic solvent based paint being insoluble to the first paint. Also, the third paint is water based paint being insoluble to the first paint and the second paint. Furthermore, the fourth paint is organic solvent based paint being insoluble to the third paint.

By using organic solvent based paint being insoluble to each other as the first paint and the second paint, a sheet attack can be prevented between the first green sheet 10a (FIG. 2) formed by the first paint and the first electrode pattern layer 12a formed by the second paint.

Also, by using water based paint being insoluble to the first paint and the second paint as the third paint, when forming the second layer (the second green sheet 10b formed by the third paint), permeation of paint from the second layer to the first layer (the first electrode pattern layer 12a formed by the second paint and the first blank pattern layer 24a formed by the first paint) can be prevented. Therefore, such disadvantages that the sheet thickness does not become even and formation of pinholes, etc. hardly arise.

Furthermore, by using paints being insoluble to each other as the third paint and the fourth paint, a sheet attack can be prevented between the second green sheet 10b formed by the third paint and the second electrode pattern layer 12b formed by the fourth paint.

In the production method of the present embodiment, the first paint includes at least either one of a butyral resin and an acrylic resin as the binder resin. Also, the third paint includes at least either one of a water-soluble polyvinyl acetal resin and a water-soluble acrylic resin.

Comparing with resins being soluble to water based paint, such as a water-soluble polyvinyl acetal resin and a water-soluble acrylic resin, resins being soluble to organic solvent based paint, such as a butyral resin and an acrylic resin, have higher resin strength. Accordingly, when forming the first green sheet 10a from the first paint including a butyral resin or an acrylic resin, the sheet strength improves. As a result, when peeling the multilayer unit U1 from the carrier sheet 20, it is possible to prevent damaging of the first green sheet 10a.

According to the production method of the present embodiment, even when the green sheet is formed to be thin as preferably 1.0 μm or thinner, and more preferably 0.5 μm or thinner, a sheet attack can be effectively prevented. As a result, a short-circuiting defect rate of the multilayer ceramic capacitor 2 can be lowered.

The present invention is not limited to the above embodiment and may be variously modified within the scope of the present invention. For example, the method of the present invention is not limited to a production method of a multilayer ceramic capacitor and may be applied as a production method of other multilayer ceramic electronic devices.

In the above embodiment, as shown in FIG. 2, a blank pattern layer is formed on spaces of patterns on each electrode pattern layer, however, the blank pattern layer is not necessarily formed in the present invention. Even when the blank pattern layer is not formed, the basic effects of the present invention can be obtained.

Also, the series of stacking steps shown in FIG. 2 may be performed twice continuously to form the multilayer unit U2 shown in FIG. 3. This embodiment also exhibits the same effects as those in the above embodiment. Furthermore, the multilayer unit U2 has the electrode pattern layers twice as much as those in the multilayer unit U1. Accordingly, it is possible to reduce the number of times of stacking the multilayer units to simplify the production steps and reduce the production cost. Also, the multilayer unit U2 has a thickness twice as thick as that of the multilayer unit U1, so that it is harder to be damaged comparing with the multilayer unit U1.

### EXAMPLES

Below, the present invention will be explained based on furthermore detailed examples, but the present invention is not limited to these examples.

[Sample 1]

First, the following components were mixed at a predetermined ratio and a dielectric material for the first paint was obtained. BaTiO₃ (having an average particle diameter of 0.2 μm: BT02 made by Sakai Chemical Industry Co., Ltd.): 100 mol %, Y₂O₃: 2.0 mol %, MgO: 2.0 mol %, MnO: 0.4 mol %, V₂O₅: 0.1 mol %, (Ba_{0.6} Ca_{0.4})SiO₃: 3.0 mol %

Next, the dielectric material in an amount of 100 parts by weight, a dispersant (a polymer based dispersant: SN5468 made by San Nopco Limited) in an amount of 1.0 part by weight and ethanol in an amount of 100 parts by weight were put together with zirconia balls (2 mmφ) in a polyethylene container, mixed for 16 hours and a dielectric mixture solution was obtained. Next, the dielectric mixture solution was dried at a drying temperature of 120° C. for 12 hours and a dielectric powder was obtained.

Next, the dielectric powder in an amount of 100 parts by weight, methylethyl ketone (NEK) as a solvent in an amount of 50 parts by weight, toluene in an amount of 20 parts by weight and a block type dispersant (JP4 made by Uniqema Corporation) were mixed by a ball mill for 4 hours to perform first-order dispersion of the compounds.

Next, the dispersion after the primary dispersing was added with an organic vehicle including a butyral resin (BH6: alcohol mixed 15% solvent made by Sekisui Chemical Co., Ltd.) as a binder resin and dioctyl phthalate (DOP) as a plasticizer. These were mixed by a ball mill for 16 hours to secondarily disperse of the components, so that first paint was obtained.

Next, as shown in FIG. 2, the first paint was applied to be a thickness of 0.5 μm on a PET film (carrier sheet 20) by die coating so as to form a first green sheet 10a. Then, the first green sheet 10a formed on the PET film was successively fed into a drying furnace to dry a solvent included in the first green sheet 10a. The drying temperature was 75° C., and the drying time was 2 minutes.

Next, on a surface of the first green sheet 10a formed on the PET film, a second paint (Ni paste composed of a solvent, etc. of a kind being insoluble to the first paint) was applied by a screen printing method to form a first electrode pattern layer 12a. Then, the first electrode pattern layer 12a formed on the first green sheet 10a was successively fed into a drying furnace to dry at 90° C. for 10 minutes.

Next, on spaces, where the first electrode pattern layer 12a is not formed, on a surface of the first green sheet 10a, the first paint was applied by a screen printing method and a first blank pattern layer 24a was formed. Then, the first blank pattern layer 24a formed on the first green sheet 10a was successively fed into a drying furnace and dried at 90° C. for 10 minutes.

Next, the above dielectric powder in an amount of 100 parts by weight, ion exchange water in an amount of 60 parts by weight and graft polymer type dispersant (AKH-0531 made by NOF Corporation) in an amount of 1 part by weight and acetylene diol based surfactant (Surfynol 465 made by Air Products and Chemicals Inc.) were mixed by a ball mill for 4 hours to primarily disperse on the components.

Next, the dispersion after the primary dispersing was added with a solvent of a water-soluble polyvinyl acetal resin (KW3: 20% aqueous solution made by Sekisui Chemical Co., Ltd.) as a binder resin and polyethylene glycol (PEG400) as a plasticizer and mixed by a ball mill for 16 hours to secondarily disperse the components. As a result, third paint (water based paint) being insoluble to the first paint and the second paint was obtained.

Next, the third paint was applied to be a thickness of 1.0 μm on a surface of the first electrode pattern layer 12a and the first blank pattern layer 24a by die coating to form a second green sheet 10b. Then, the second green sheet 10b formed on a surface of the first electrode pattern layer 12a and the first blank pattern layer 24a was successively fed into a drying furnace to dry the solvent. The drying temperature was 75° C. and the drying time was 2 minutes.

Next, on a surface of the second green sheet 10b formed on the surface of the first electrode pattern layer 12a and the first blank pattern layer 24a, a fourth paint (Ni paste composed of an organic solvent kind, etc. being insoluble to the third paint) is applied by a screen printing method so as to form a second electrode pattern layer 12b. The second electrode pattern layer 12b formed on the second green sheet 10b was successively fed into a drying furnace and dried at 90° C. for 10 minutes.

Next, on spaces, where the second electrode pattern layer 12b is not formed, on a surface of the second green sheet 10b, the third paint was applied by a screen printing method to form a second blank pattern layer 24b. Then, the second blank pattern layer 24b formed on the second green sheet 10b was successively fed into a drying furnace and dried at 90° C. for 10 minutes.

Next, the first paint was applied to be a thickness of 0.5 μm on a surface of the second electrode pattern layer 12b and the second blank pattern layer 24b by die coating to form a third green sheet 10c. Then, the third green sheet 10c formed on the second electrode pattern layer 12b and the second blank pattern layer 24b was successively fed into a drying furnace and the solvent was dried. The drying temperature was 75° C. and the drying time was 2 minutes. After drying, a multilayer unit U1 was obtained. A plurality of number of the multilayer units U1 were produced.

Next, after peeling the carrier sheet 20 from each of the multilayer units U1, as shown in FIG. 3, the multilayer units U1 were stacked successively in a positional relationship that the first green sheet 10a of one multilayer unit U1 contacts with the third green sheet 10c of an adjacent multilayer unit U1, heated and pressurized to bond, and a multilayer body was obtained.

Next, the multilayer body was cut into a predetermined size to obtain a ceramic green chip. Then, the ceramic green chip was heated and binder removal processing was performed. Then, the ceramic green chip was fired at 1000° C. to 1400° C., and a sintered body was obtained. Then, the sintered body was heated to re-oxidize dielectric layers in the sintered body. Terminal electrodes were formed on the sintered body after the re-oxidization processing, and a multilayer ceramic capacitor was obtained.

A size of the multilayer ceramic capacitor was 1.6 mm in length and 0.8 mm in width. The number of stacked layers (the number of electrode pattern layers) was 100.

Next, multilayer ceramic capacitor samples 2 to 7 below were produced. Kinds of the first to fourth paint used for producing the samples are shown in Table 1. The samples 1 to 4 have common features that the first paint is organic solvent based paint, the second paint is organic solvent based paint being insoluble to the first paint, the third paint is water based paint being insoluble to the first paint and second paint, and the fourth paint is organic solvent based paint being insoluble to the third paint.

TABLE 1
Table 1

| | First Paint | | Second Paint | | | Fourth Paint |
|---|---|---|---|---|---|---|
| | (First and | | (First Electrode | Third Paint | | (Second Electrode |
| | Third Green | Binder Resin | Pattern | (Second | Binder Resin | Pattern |
| | Sheet) | of First Paint | Layer) | Green Sheet) | of Third Paint | Layer) |
| Sample 1 | Organic Solvent Based | Butyral Resin | Organic Solvent Based | Water Based Paint | Water-Soluble Polyvinyl | Organic Solvent Based |
| | Paint | | Paint (Insoluble) | | Acetal Resin | Paint (Insoluble) |
| Sample 2 | Organic Solvent Based | Acrylic resin | Organic Solvent Based | Water Based Paint | Water-Soluble Acrylic | Organic Solvent Based |
| | Paint | | Paint (Insoluble) | | Resin | Paint (Insoluble) |
| Sample 3 | Organic Solvent Based | Butyral Resin | Organic Solvent Based | Water Based Paint | Water-Soluble Acrylic | Organic Solvent Based |
| | Paint | | Paint (Insoluble) | | Resin | Paint (Insoluble) |
| Sample 4 | Organic Solvent Based | Acrylic resin | Organic Solvent Based | Water Based Paint | Water-Soluble Polyvinyl | Organic Solvent Based |
| | Paint | | Paint (Insoluble) | | Acetal Resin | Paint (Insoluble) |
| Sample 5 | Organic Solvent Based | Butyral Resin | Organic Solvent Based | Water Based Paint | Water-Soluble Polyvinyl | Organic Solvent Based |
| | Paint | | Paint (Insoluble) | | Acetal Resin | Paint (Insoluble) |
| Sample 6 | Organic Solvent Based | Acrylic resin | Organic Solvent Based | Water Based Paint | Water-Soluble Acrylic | Water Based Paint |
| | Paint | | Paint (Insoluble) | | Resin | (Soluble) |
| Sample 7 | Water Based Paint | Water-Soluble | Organic Solvent | Organic Solvent Based | Butyral Resin | Organic Solvent Based |
| | | Polyvinyl | Paint | Based Paint | | Paint (Insoluble) |
| | | Acetal Resin | | | | |

Sample 2

In the sample 2, an acrylic resin was included as a binder resin in the first paint, and a water-soluble acrylic resin was included as a binder resin in the third paint. Other than that, the multilayer ceramic capacitor sample 2 was produced under the same condition as that in the sample 1.

Sample 3

In the sample 3, a water-soluble acrylic resin was included as a binder resin in the third paint. Other than that, the multilayer ceramic capacitor sample 3 was produced under the same condition as that in the sample 1.

Sample 4

In the sample 4, an acrylic resin was included as a binder resin in the first paint. Other than that, the multilayer ceramic capacitor sample 4 was produced under the same condition as that in the sample 1.

Sample 5

In the sample 5, organic solvent based paint being soluble to the first paint was used as the second paint. Other than that, the multilayer ceramic capacitor sample 5 was produced under the same condition as that in the sample 1.

Sample 6

In the sample 6, an acrylic resin was included as a binder resin in the first paint, and a water-soluble acrylic resin was included as a binder resin in the third paint. Also, water based paint being soluble to the third paint was used as the fourth paint. Other than that, the multilayer ceramic capacitor samples 6 were produced under the same condition as that in the sample 1.

Sample 7

In the sample 7, water based paint was used as the first paint. A water-soluble polyvinyl acetal resin was included as a binder resin in the first paint. Furthermore, organic solvent based paint being soluble to the second paint was used as the third paint. Polyvinyl butyral was included as a binder resin in the third paint. Other than that, the multilayer ceramic capacitor sample 7 was produced under the same condition as that in the sample 1.

[Evaluation]

Measurement of Peeling Strength

Peeling strength (N/cm) of the carrier sheet 20 was measured on one sample of each of the multilayer units U1 (FIG. 2) obtained in the samples 1 to 7. Peeling strength was measured by pulling up one end of the carrier sheet 20 of the multilayer unit U1 to the direction of 90 degrees with respect to a surface of the stacked layers of the multilayer unit U1 at a speed of 8 mm/minute, and a force (N/cm) imposed to the carrier sheet was measured when the carrier sheet 20 was peeled from the multilayer unit U1. This force was used as peeling strength of the carrier sheet. By lowering the peeling strength, the carrier sheet 20 can be preferably peeled from the multilayer unit U1 and it is possible to effectively prevent damaging of the multilayer unit U1 when peeling. Accordingly, the lower the peeling strength is, the better. The results are shown in Table 2.

TABLE 2
Table 2

| | Peeling | | | |
|---|---|---|---|---|
| | Strength | Stacking Force | | Short-Circuiting |
| | [N/cm] | [N/cm²] | Sheet Attack | Defect Rate [%] |
| Sample 1 | 0.039 | 30 | Not Existed | 5.0 |
| Sample 2 | 0.042 | 27 | Not Existed | 6.0 |
| Sample 3 | 0.039 | 31 | Not Existed | 7.0 |
| Sample 4 | 0.042 | 26 | Not Existed | 6.0 |
| Sample 5 | 0.039 | 30 | Existed | 30.0 |
| Sample 6 | 0.042 | 27 | Existed | 35.0 |
| Sample 7 | 0.059 | 10 | Not Existed | 40.0 |

As shown in Table 2, it was confirmed that the samples 1 to 6 using organic solvent based paint as the first paint exhibited lower peeling strength of the carrier sheet 20 comparing with that of the sample 7 using water based paint as the first paint. Namely, in the samples 1 to 6, the carrier sheets 20 were confirmed to be easily peeled off from the multilayer unit U1.

On the other hand, in the sample 7 using water based paint as the first paint, it was confirmed that the peeling strength of the carrier sheet 20 was higher comparing with those in the samples 1 to 6 using organic solvent based paint as the first paint. Namely, it was confirmed that the carrier sheet 20 was hard to be peeled from the multilayer unit U1 in the sample 7 using the water based paint as the first paint.

Measurement of Stacking Strength

A stacking force (N/cm²) was measured on one multilayer body (pressed stacked body) obtained by pressing two of multilayer unit U1 samples obtained in the samples 1 to 7. An average value of a stacking forces of all samples is shown in Table 2. In the measurement, a tensile testing machine INSTRON 5543 was used. Note that a stacking force is a force required to peel the green sheet from the electrode pattern layer and the blank pattern layer in the multilayer body. The larger the stacking force is, the better the adhesiveness between the green sheet and the electrode pattern layer and the blank pattern layer is, and the less the parts with adhering defects are between them.

As shown in Table 2, in the samples 1 to 6, wherein the first green sheet and the third green sheet includes a butyral resin or an acrylic resin, the stacking force was confirmed to be larger than that in the sample 7. Namely, adhesiveness between sheets was more excellent in the multilayer bodies in the samples 1 to 6 comparing with that in the sample 7.

On the other hand, in the sample 7, wherein the first green sheet and the third green sheet include a water-soluble polyvinyl acetal resin or a water-soluble acrylic resin, a stacking force was confirmed to be smaller comparing with those in the samples 1 to 6.

Measurement of Existence of Sheet Attack

A degree of arising of sheet attacks was measured on samples of non-fired ceramic green chips obtained in the samples 1 to 7.

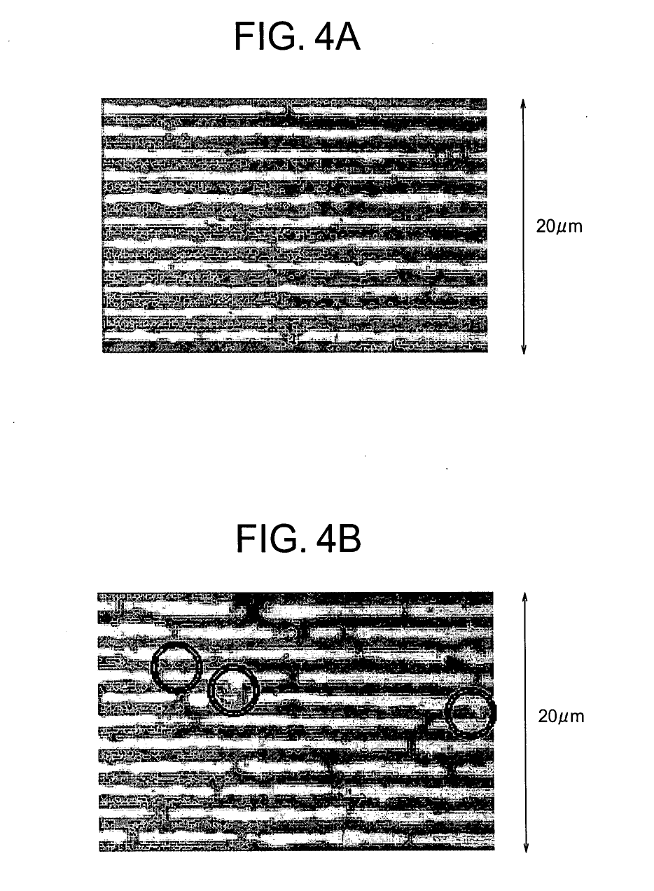

The measurement was made by burying 100 of the green chip samples in 2-solution curing epoxy resin, so that sides of the dielectric layers and internal electrode layers expose and, then, curing the 2-solution epoxy resin. Then, the green chip samples buried in the epoxy resin were polished to a depth of 1.6 mm by using sand papers. Note that polishing by sand papers was performed by using #400 sand paper, #800 sand paper, #1000 sand paper and #2000 sand paper in this order. Next, mirror finish processing was performed by using diamond paste on the surface polished by the sand papers. Then, an optical microscope with a magnification of 400 times was used to observe the polished surface after the mirror finish processing to check an existence of sheet attacks. The results are shown in Table 2. Also, sectional pictures of the sample 1 and sample 5 are shown in FIG. 4.

Note that whether a sheet attack arises or not was determined whether a thickness of the green sheet became partially extremely thin to 50% or less or not comparing with other parts. In Table 2, based on the observation by an optical microscope, when a ratio of the number of samples exhibited sheet attacks to the total number of measured samples was 10% or higher, it was evaluated that sheet attacks “existed”, and in other cases, it was evaluated that sheet attacks did “not exist”.

As shown in Table 2, in the samples 1 to 4 and 7, almost no sheet attack was observed. On the other hand, in the sample 5 wherein the first paint and the second paint were soluble to each other and in the sample 6 wherein the third paint and the fourth paint were soluble to each other, sheet attacks were observed.

Next, FIG. 4 will be explained. In FIG. 4, white horizontal lines are electrode patterns, and between the electrode patterns are the dielectric layers. In the sectional picture of the sample 1 shown in FIG. 4A, sheet attacks were not observed. On the other hand, in the sectional picture of the sample 5 shown in FIG. 4B, sheet attacks were observed as seen in parts surrounded by double circles in the figure.

Measurement of Short-Circuiting Defect Rate

A short-circuiting defect rate was measured on 100 of multilayer ceramic capacitor samples obtained in the samples 1 to 7. The results are shown in Table 2. The measurement was made by using an insulation-resistance tester (E2377A Multi-meter made by Hewlett Packard). A resistance value of each sample was measured and samples having a resistance value of 100 kΩ or lower were determined as samples with short-circuiting. A ratio of the short-circuiting samples to all measured samples was considered as the short-circuiting defect rate (%).

As shown in Table 2, in the samples 1 to 4, it was confirmed that the samples 1 to 4 exhibited lower short-circuiting defect rates comparing with those in the sample 5, wherein the first paint and the second paint are soluble to each other, and the sample 6, wherein the third paint and the fourth paint are soluble to each other, and the sample 7, wherein the second paint and the third paint are soluble to each other. On the other hand, it was confirmed that samples 5 to 7 exhibited higher short-circuiting defect rates comparing with those in the samples 1 to 4.

1. A production method of a multilayer ceramic electronic device, comprising the steps of:
forming a first green sheet by first paint; and
forming a first electrode pattern layer by second paint so as to contact with said first green sheet;
wherein said first paint and said second paint are insoluble to each other.

2. The production method of a multilayer ceramic electronic device as set forth in claim 1, wherein a thickness t1 of said first green sheet is 1.0 μm or thinner.

3. The production method of a multilayer ceramic electronic device as set forth in claim 1, comprising the steps of:
forming a second green sheet by third paint on a surface of said first green sheet having said first electrode pattern layer formed thereon; and
forming a second electrode pattern layer by fourth paint on a surface of said second green sheet;
wherein:
said third paint is insoluble to said first paint and said second paint; and
said third paint and said fourth paint are insoluble to each other.

4. The production method of a multilayer ceramic electronic device as set forth in claim 3, wherein a thickness t2 of said second green sheet is 1.0 μm or thinner.

5. The production method of a multilayer ceramic electronic device as set forth in claim 3, comprising the step of forming a third green sheet by said first paint on a surface of said second green sheet having said second electrode pattern layer formed thereon.

6. The production method of a multilayer ceramic electronic device as set forth in claim 5, comprising the steps of:
forming a plurality of multilayer units having said first green sheet, said first electrode pattern layer, said second green sheet, said second electrode pattern layer and said third green sheet on a carrier sheet;
peeling said carrier sheet from each of said multilayer units; and
stacking a plurality of said multilayer units, so that adjacent two multilayer units are in a relationship that said first green sheet included in one of the multilayer units contacts with said third green sheet included in the other multilayer unit.

7. The production method of a multilayer ceramic electronic device as set forth in claim 6, wherein a sum of a thickness t1 of said first green sheet and a thickness t3 of said third green sheet (t1+t3) is equal to a thickness t2 of said second green sheet.

8. The production method of a multilayer ceramic electronic device as set forth in claim 3, wherein:
said first paint is organic solvent based paint;
said second paint is organic solvent based paint being insoluble to said first paint;
said third paint is water based paint being insoluble to said first paint and said second paint; and
said fourth paint is organic solvent based paint being insoluble to said third paint.

9. The production method of a multilayer ceramic electronic device as set forth in claim 8, wherein said first paint includes at least either one of a butyral resin and an acrylic resin as a binder resin.

10. The production method of a multilayer ceramic electronic device as set forth in claim 8, wherein said third paint includes at least either one of a water-soluble polyvinyl acetal resin and a water-soluble acrylic resin as a binder resin.

11. The production method of a multilayer ceramic electronic device as set forth in claim 1, wherein a first blank pattern layer formed by said first paint is formed to have substantially the same thickness as that of said first electrode pattern layer on a part of a surface of said first green sheet, where said first electrode pattern layer is not formed.

12. The production method of a multilayer ceramic electronic device as set forth in claim 3, wherein a second blank pattern layer formed by said third paint is formed to have substantially the same thickness as that of said second electrode pattern layer on a part of a surface of said second green sheet, where said second electrode pattern layer is not formed.
